(19) United States
(12) Patent Application Publication
(10) Pub. No.: US 2005/0064270 A1
(43) Pub. Date: Mar. 24, 2005

(54) Fuel cell bipolar separator plate

(76) Inventor: Leonard G. Marianowski, Mount Prospect, IL (US)

Correspondence Address: MARK E. FEJER;GAS TECHNOLOGY INSTITUTE, 1700 SOUTH MOUNTAIN PROSPECT ROAD, DES PLAINES, IL, 60018, US

(21) Appl. No.: 10/669,242

(22) Filed: Sep. 24, 2003

(51) Int. Cl. H01M 8/02; H01M 8/04; H01M 8/10; H01M 8/12; H01M 8/08

(52) U.S. Cl. 429/38; 429/26; 429/32; 429/46

(57) ABSTRACT

A bipolar separator plate for a fuel cell stack constructed of at least two coextensive sheet metal elements shaped to promote the distribution of reactant gases to the electrodes of the fuel cell units of the fuel cell stack. The coextensive sheet metal elements are corrugated and fitted together to form at least one coolant flow channel between corresponding peaks, or valleys, of the corrugations of the sheet metal elements.

### BACKGROUND OF THE INVENTION

1. Field of the Invention

This invention relates to a bipolar separator plate for use in fuel cell systems. More particularly, this invention relates to a fluid cooled, bipolar sheet metal separator plate for use in fuel cell stacks. This invention is applicable to all fuel cell types, including molten carbonate, solid oxide, phosphoric acid and polymer electrolyte membrane fuel cells. Although the concept of this invention may be applied to bipolar separator plates for a variety of fuel cell designs, it is particularly suitable for use in fuel cell stacks in which the fuel and oxidant are provided to each of the fuel cell units comprising the fuel cell stack through internal manifolds.

2. Description of Related Art

There are a number of fuel cell systems currently in existence and/or under development which have been designed and are proposed for use in a variety of applications including power generation, automobiles, and other applications where environmental pollution is to be avoided. These include molten carbonate fuel cells, solid oxide fuel cells, phosphoric acid fuel cells, and polymer electrolyte membrane fuel cells. One issue associated with successful operation of each of these fuel cell types is the control of fuel cell temperature and the removal of products generated by the electrochemical reactions from within the fuel cell.

Commercially viable fuel cell stacks may contain several hundred individual fuel cells (or fuel cell units), each having a planar area, depending upon fuel cell type, up to several square feet. In a fuel cell stack, a plurality of fuel cell units are stacked together in electrical series, separated between the anode electrode of one fuel cell unit and the cathode electrode of an adjacent fuel cell unit by an impermeable, electrically conductive, bipolar separator plate which provides reactant gas distribution on both external faces thereof, which conducts electrical current between the anode of one cell and the cathode of the adjacent cell in the stack, and which, in most cases, includes the internal passages therein which are defined by internal heat exchange faces and through which coolant flows to remove heat from the stack. Such a bipolar separator plate is taught, for example, by U.S. Pat. No. 5,776,624. In such fuel cell stacks, the fuel is introduced between one face of the separator plate and the anode side of the electrolyte and oxidant is introduced between the other face of the separator plate and the cathode side of a second electrolyte.

Cell stacks containing several hundred cells present serious problems with respect to maintaining cell integrity during heat-up and operation of the fuel cell stack. Due to thermal gradients between the cell assembly and cell operating conditions, differential thermal expansions, and the necessary strength of materials required for the various components, close tolerances and very difficult engineering problems are presented. In this regard, cell temperature control is highly significant and, if it is not accomplished with a minimum temperature gradient, uniform current density will not be maintainable, and degradation of the cell will occur.

In addition to temperature considerations, fuel cell stack integrity is also a function of the physical dimensions of the stack. The larger the fuel cell stack, the more difficult it becomes to maintain stack integrity and operation. Accordingly, in addition to temperature control, for a given electrical output which is a function of the number of fuel cell units comprising the fuel cell stack, it is desirable that the fuel cell stack dimensions, in particular, the fuel cell stack height be as small as possible for a given electrical output.

Polymer electrolyte membrane fuel cells, which are well known in the art, are particularly advantageous because they are capable of providing potentially high energy output while possessing both low weight and low volume. Each such fuel cell comprises a “membrane-electrode-assembly” comprising a thin, proton-conductive, polymer membrane-electrolyte having an anode electrode film formed on one face thereof and a cathode electrode film formed on the opposite face thereof. In general, such membrane-electrolytes are made from ion exchange resins, and typically comprise a perflourinated sulfonic acid polymer such as NAFION™ available from E.I. DuPont DeNemours & Co. The anode and cathode films typically comprise finely divided carbon particles, very finely divided catalytic particles supported on the internal and external surfaces of the carbon particles, and proton-conductive material intermingled with the catalytic and carbon particles, or catalytic particles dispersed throughout a polytetrafluoroethylene (PTFE) binder.

The membrane-electrode-assembly for each fuel cell is sandwiched between a pair of electrically conductive elements which serve as current collectors for the anode/cathode and frequently contain an array of grooves in the faces thereof for distributing the fuel cell gaseous reactants over the surfaces of the respective anode and cathode.

### SUMMARY OF THE INVENTION

Accordingly, it is one object of this invention to provide a fuel cell stack having a compact design such that the number of fuel cell units per inch of fuel cell stack height for a given electrical output is increased over conventional fuel cell stacks of a corresponding type.

It is another object of this invention to provide a compact, fluid cooled bipolar separator plate for use in fuel cell stacks.

It is another object of this invention to provide a fluid cooled bipolar separator plate for use in fuel cell stacks having enhanced conductivity properties.

These and other objects of this invention are addressed by a fuel cell stack comprising a plurality of substantially planar fuel cell units. Each fuel cell unit comprises an anode electrode, a cathode electrode, and an electrolyte disposed therebetween. A bipolar separator plate is disposed between the anode electrode of one fuel cell unit and the cathode electrode of an adjacent fuel cell unit. The bipolar separator plate comprises guide means for distributing fuel and oxidant to the anode electrode and the cathode electrode, respectively. The separator plate is constructed of at least two substantially coextensive sheet metal elements having a substantially flat peripheral region and a central region comprising a plurality of substantially uniform corrugations. The corrugations of the sheet metal elements have substantially equal peak-to-peak distances. In addition, the corrugations of the first of the sheet metal elements have a peak-to-valley distance greater than the peak-to-valley distance of the corrugations of the second of the sheet metal elements. The sheet metal elements are aligned whereby each corrugation valley of each corrugation of the first sheet metal element contacts a corresponding corrugation valley of the second sheet metal element, forming a coolant flow channel between each corrugation peak of the corrugations of the first sheet metal element and the corresponding corrugation peak of the corrugations of the second sheet metal element.

### BRIEF DESCRIPTION OF THE DRAWINGS

These and other objects and features of this invention will be better understood from the following detailed description taken in conjunction with the drawings wherein:

FIG. 1 is an exploded perspective view of a portion of a polymer electrolyte membrane fuel cell stack including separator plates in accordance with one embodiment of this invention;

FIG. 2 is a top view of a separator plate in accordance with one embodiment of this invention for a fuel cell stack;

FIG. 3 is a cross-sectional view of a portion of the separator plate shown in FIG. 2 in the direction of arrows III-III;

FIG. 4 is a plan view of an electrode facing side of a sheet metal element of a separator plate in accordance with one embodiment of this invention; and

FIG. 5 is a plan view of a cooling fluid side of a sheet metal element of a separator plate in accordance with one embodiment of this invention.

### DETAILED DESCRIPTION OF THE PRESENTLY PREFERRED EMBODIMENTS

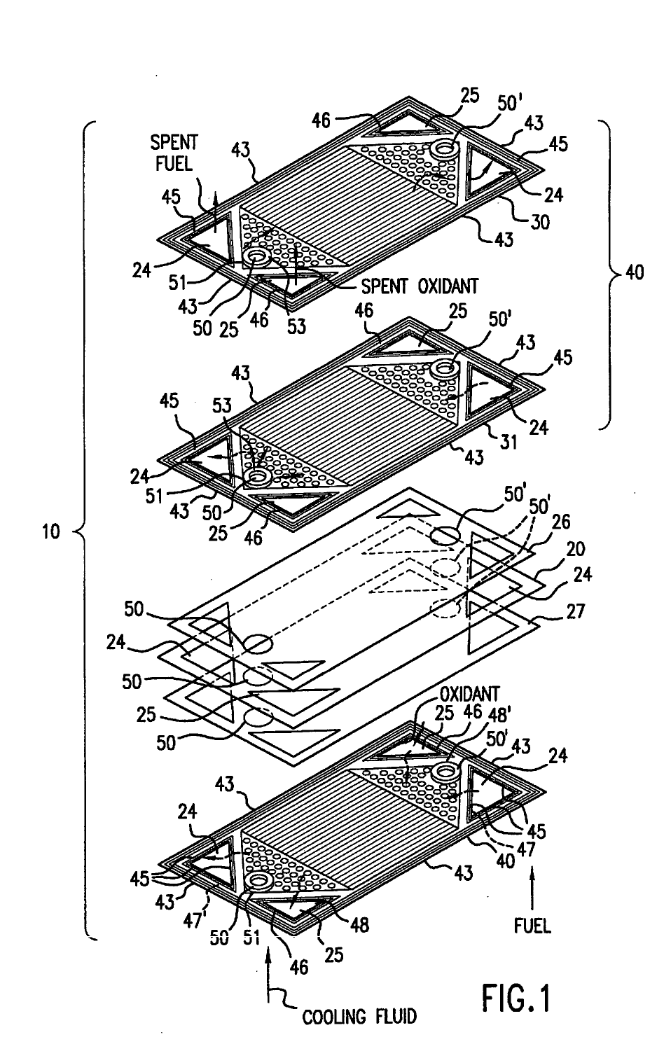

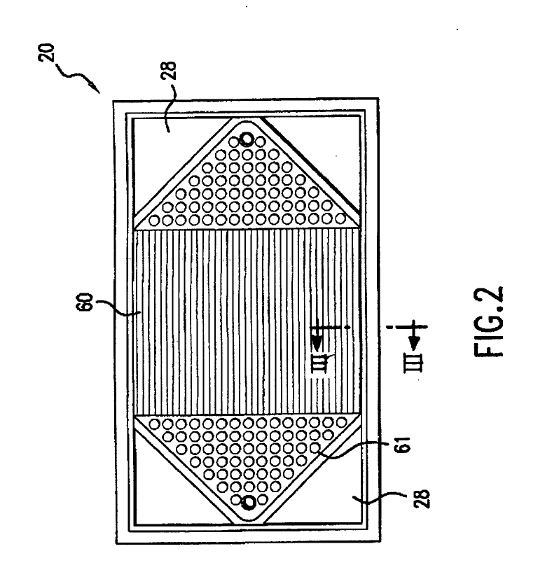

FIG. 1 is an exploded perspective view of a portion of a polymer electrolyte membrane fuel cell stack 10 in accordance with one embodiment of this invention. Although described herein in the context of a polymer electrolyte membrane fuel cell, as previously stated, this invention is suitable for use in other types of fuel cells, including molten carbonate, solid oxide and phosphoric acid, and such other types of fuel cells are deemed to be within the scope of this invention. Polymer electrolyte membrane fuel cell stack 10 comprises a plurality of polymer electrolyte membrane fuel cell units, each of which comprises a membrane-electrode-assembly (MEA) 20 comprising a thin, proton conductive, polymer membrane-electrolyte having an anode electrode film (anode) formed on one face thereof and a cathode electrode film (cathode) formed on the opposite face thereof, which membrane-electrode-assembly 20 is sandwiched between electrically conductive elements 26, 27 which serve as current collectors and gas diffusion layers for the anode and cathode. Preferably, the anode electrode film and the cathode electrode film are sized to correspond to the active centrally disposed active area of the cell. Separator plate 40 separates adjacent polymer electrolyte membrane fuel cell units and is disposed between the anode side of one said polymer electrolyte membrane fuel cell unit and the cathode side of the adjacent said polymer electrolyte membrane fuel cell unit. Separator plate 40 is formed with guide means for distribution of fuel and oxidant reactant gases to the anode and the cathode, respectively. Such guide means may take any suitable form but, in accordance with one preferred embodiment of this invention, comprise a plurality of corrugations 60, as shown in FIG. 2, which form channels for distribution of the reactant gases to the electrodes. In accordance with another embodiment of this invention, said guide means comprise a plurality of dimples 61, also shown in FIG. 2. As shown in FIG. 2, separator plate 40 may comprise a plurality of guide means, such as a combination of corrugations and dimples.

In accordance with a particularly preferred embodiment of this invention, the polymer electrolyte membrane fuel cell stack of this invention is a fully internal manifolded fuel cell stack whereby the reactant gases are provided to the electrodes and the reaction products are withdrawn from the reaction zones within the fuel cell stack through internal manifolds formed by aligned perforations disposed within at least a separator plate and the polymer electrolyte membranes. Internal manifolded fuel cells are taught by U.S. Pat. No. 4,963,442, U.S. Pat. No. 5,077,148, U.S. Pat. No. 5,227,256, and U.S. Pat. No. 5,342,706, the teachings of which are all incorporated herein by reference. It will, however, be apparent to those skilled in the art that other fuel cell configurations, including externally manifolded fuel cell stacks, are suitable for use with the separator plate of this invention.

As shown in FIG. 1, a fuel cell unit of a polymer electrolyte membrane fuel cell stack in accordance with one embodiment of this invention comprises separator plates 40, membrane electrode assembly 20 comprising a thin, proton-conductive, polymer membrane-electrolyte having an anode electrode film formed on one face thereof and a cathode electrode film formed on the opposite face thereof, anode current collector 26, and cathode current collector 27. Separator plates 40, the membrane of membrane-electrode-assembly 20, and current collectors 26,27 extend to the edge region of the cell. Seal means are provided to form seals at both faces of separator plates 40 between the membrane of membrane-electrode-assembly 20 and/or current collectors 26, 27 around the entire periphery of the cell in peripheral seal areas 43 in accordance with one embodiment of this invention. Peripheral seal structures 43 extend upwardly and downwardly from the general plane of separator plate 40 to provide contact with the periphery of current collectors 26, 27 and/or membrane-electrode-assembly 20. Separator plates 40, membrane-electrode-assembly 20, and current collectors 26,27 are each penetrated by corresponding fuel manifold holes 24, one for supply and one for removal, and oxidant manifold holes 25, one for supply and one for removal. While the manifold holes shown in FIG. 1 are a triangular shape providing easily formed straight thin sheet manifold seal areas, the manifold holes may be round, rectangular, or any other desired shape. The manifold holes shown in FIG. 1 are single openings, but partitions may be used in the single openings as desired to direct gas flow across the cell reactant chambers. Fuel manifold seal areas 45 and oxidant manifold seal areas 46 extend both upwardly and downwardly from the general plane of separator plate 40 to provide contact with the current collectors 26, 27 and/or membrane-electrode-assembly 20 to form seals between the membrane-electrode-assembly and the adjacent current collectors 26, 27.

Oxidant manifold holes 25 are sealed by oxidant manifold seals 46 providing oxidant flow only to and from the cathode chamber adjacent the upper face of separator plate 40 by oxidant supply openings 48 and oxidant exhaust openings 48′ and preventing gas flow to or from the anode chamber while fuel manifold holes 24 are sealed by fuel manifold seals 45 providing fuel flow only to and from the anode chamber adjacent the lower face of separator plate 40 by fuel supply openings 47 and fuel exhaust openings 47′ and preventing gas flow to or from the cathode chamber. Although shown as straight pressed sheet metal structures, manifold seals 45, 46 can be any desired shape or structure to prevent gas flow. Manifold seals 45, 46 form a double seal between fuel manifold hole 24 and oxidant manifold hole 25.

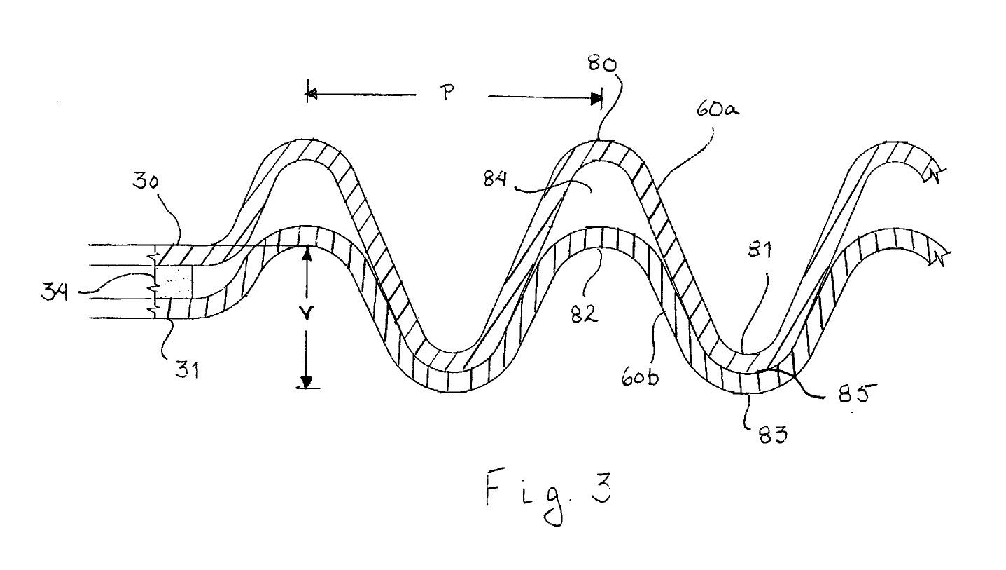

As previously stated, a substantial problem which must be addressed during the operation of polymer electrolyte membrane fuel cell stacks is the control of fuel cell temperatures generated by the electrochemical reactions of the fuel and oxidant reactants within the fuel cell units comprising the fuel cell stack. This objective is achieved by a separator plate 40 in accordance with this invention comprising at least two substantially coextensive sheet metal elements 30, 31, as shown in FIGS. 1 and 3. Sheet metal elements 30, 31 have a centralized region comprising a plurality of corrugations, 60a and 60b defined by alternating peaks 80, 82 and valleys 81, 83. It will, however, be apparent that the terms “peak” and “valley” are relative terms based upon the orientation of the sheet metal element. That is, peak 80 of sheet metal element 30 becomes a valley and valley 81 becomes a peak when sheet metal element 30 is turned over. Thus, when the term “peak” is used in connection with the description of this invention, it will be understood that the term “valley” could be used in its place without changing the basic concept of this invention.

The peak-to-peak distances, P, for corrugations 60a of sheet metal element 30 are equal to the peak-to-peak distances for corresponding corrugations 60b of sheet metal element 31. Although not a requirement, the peak-to-peak distance between all corrugations 60a of sheet metal element 30 and, thus, corrugations 60b of sheet metal element 31 are equal in accordance with a particularly preferred embodiment of this invention.

In contrast to the equal peak-to-peak distances between the corrugations 60a of sheet metal element 30 and corresponding corresponding corrugations 60b of sheet metal element 31, the corrugation heights of corrugations 60a and 60b, as defined by the peak-to-valley distance V as shown in FIG. 3 are not equal. Thus, when sheet metal elements 30, 31 are properly aligned, the valleys 81 of sheet metal element 30 contact the corresponding valleys 83 of sheet metal element 31 and coolant flow spaces or channels 84 are formed between the peaks 80 of sheet metal element 30 and corresponding peaks 82 of sheet metal element 31. By virtue of this arrangement, there results a substantial contact region 85 between the corresponding valleys 81, 83 of sheet metal elements 30. 31, which extends along the entire length of the corrugations, providing for a substantial improvement in conductivity compared to conventional multi-element bipolar separator plates.

It will also be apparent to those skilled in the art that a bipolar separator plate 40 comprising more than two coextensive sheet metal elements arranged as described herein above, whereby a coolant flow space or channel is maintained between the corrugation peaks of each of the individual sheet metal elements, may also be employed in a fuel cell stack in accordance with this invention.

In order to provide coolant to coolant flow channels 84, separator plate 40, membrane-electrode-assembly 20, and current collectors 26,27 are provided with coolant fluid manifold openings 50,50′, for input and output of cooling fluid. Coolant fluid manifold sealant areas 51 extend on both faces from the general plane of separator plate 40 to provide contact for forming seals between separator plate 40 and membrane-electrode-assembly 20 and/or current collectors 26,27 and define a coolant fluid manifold. Coolant fluid manifold openings 50,50′ are the same diameter in each of the cell components to allow the flat surface of the coolant fluid manifold seal areas 51 to force contact between membrane-electrode-assembly 20 and anode current collector 26 on one side and between membrane-electrode-assembly 20 and cathode current collector 27 on the other side to form a seal surrounding the coolant fluid manifold. The side walls of the extended coolant fluid manifold seal areas 51 are solid in separator plates 40 and, thus, preclude entry of cooling fluid into either the anode chamber or the cathode chamber. Coolant fluid openings 53 in the side walls of the extended coolant fluid manifold seal areas 51 provide for communication between coolant fluid manifold openings 50, 50′ and coolant flow channels 84.

Another object of this invention is to provide a fuel cell stack having a higher power density than conventional fuel cell stacks. By arranging the sheet metal elements comprising the bipolar separator plate in accordance with this invention, it is possible to provide a fuel cell stack made up of 15-30 fuel cell units per inch of fuel cell stack. That is, a one foot high fuel cell stack of polymer electrolyte membrane fuel cells in accordance with this invention could contain up to 360 fuel cell units. If each fuel cell unit has an area of about one square foot, then a power density of 86,400 watts/ft³, or 3,050 watts per liter is obtained (360 fuel cell units×400 amps per foot squared×0.6 v/cell).

Bipolar separator plate 40, as previously stated, comprises at least two coextensive sheet metal elements 30, 31 which are fitted together and form coolant flow channels 84 therebetween as described herein above. The distance between the corresponding peaks 80, 82 of corrugations 60a, 60b of coextensive sheet metal elements 30, 31 is such as to maintain as low a coolant fluid pressure differential through the coolant flow channels 84 as possible. In accordance with a preferred embodiment of this invention, the distance between the corresponding peaks 80, 82 of coextensive sheet metal elements 30, 31 is in the range of about 0.010 inches to about 0.10 inches. Coextensive sheet metal elements 30, 31 are preferably constructed of nickel, stainless steel, high alloy steel, titanium and/or metals coated to prevent corrosion, having a thickness in the range of about 0.002 to about 0.006 inches. In accordance with a particularly preferred embodiment in which the fuel cell units are polymer electrolyte membrane fuel cells, the bipolar plate comprises a chromium-nickel austenitic alloy, wherein the chromium and nickel, on a combined basis, comprises at least 50% by weight of the alloy. In accordance with a particularly preferred embodiment, the percentage by weight of nickel in the alloy is greater than the percentage of chromium.

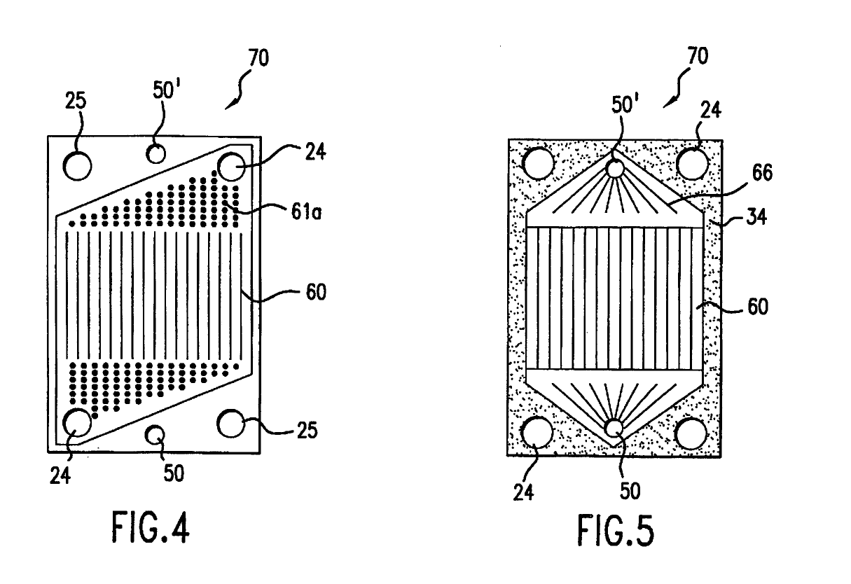

FIG. 4 shows a plan view of an electrode facing face of a sheet metal element 70 of a separator plate in accordance with one embodiment of this invention. The center portion of sheet metal element 70 is the active area and comprises guide means in the form of corrugation 60 for distributing gaseous reactants to one of the electrodes of a membrane electrode assembly, which guide means are typically pressed into said sheet metal element 70. The areas of sheet metal element 70 surrounding the active area, which areas provide sealing between the sheet metal elements 70 comprising the separator plate of this invention and between the separator plate and adjacent elements of a fuel cell stack, are generally flat. To assist in the distribution of reactant gases to the electrodes, a portion of the flat areas corresponding generally to the dimpled section of the separator plate shown in FIG. 2 are provided with reactant gas guide means for distributing the reactant gases to the active area of the separator plate. Unlike the dimples 61 shown in FIG. 2 which are normally formed by pressing of the sheet metal element, the guide means shown in FIG. 4, which are also in the form of dimples 61a are applied to the flat portion of the sheet metal element 70 by a print screening process known to those skilled in the art. It will also be apparent to those skilled in the art that other forms of print screened guide means, such as rails, may also be employed and are deemed to be within the scope of this invention.

FIG. 5 is a plan view of the cooling fluid facing side of sheet metal element 70, which comprises corrugated and flat sections corresponding to the corrugated and flat sections on the electrode facing side of sheet metal element 70. As shown in FIGS. 4 and 5, the flat portions of sheet metal element 70 comprise the periphery of sheet metal element 70 as well as surround the gas manifold openings 24, 25 and the cooling fluid manifold openings 50, 50′. As shown in FIG. 3, sealing between sheet metal elements 30, 31 is provided by a gasket material 34 which extends around the periphery of the separator plate as well as around the manifold openings formed by the sheet metal elements 30, 31. Gasket material 34 may be any sealing material suitable for performing the function. In accordance with one preferred embodiment of this invention, the gasket is formed by screen printing directly onto the flat portions of sheet metal element 70.

To distribute the cooling fluid entering cooling fluid channels 84 through cooling fluid opening 50, the flat portions of sheet metal element 70 on the cooling fluid facing side thereof are provided with cooling fluid guide means which are also screen printed thereon. Said cooling fluid guide means are preferably in the form of dimples or rails 66. In addition to providing means for distributing the cooling fluid, the cooling fluid guide means, as well as the gasket 34, are suitable for maintaining a separation between the sheet metal elements.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

1. In a fuel cell stack comprising a plurality of substantially planar fuel cell units, each said fuel cell unit having an anode electrode, a cathode electrode, and an electrolyte disposed therebetween, and a separator plate disposed between said anode electrode of one said fuel cell unit and said cathode electrode of an adjacent said fuel cell unit, said separator plate comprising guide means for distributing fuel and oxidant to said anode electrode and said cathode electrode, respectively, the improvement comprising:
said separator plate constructed of at least two substantially coextensive sheet metal elements having a substantially flat peripheral region and a central region comprising a plurality of substantially uniform corrugations, said corrugations of a first of said sheet metal elements and a second of said sheet metal elements having substantially equal peak-to-peak distances and said corrugations of said first of said sheet metal elements having a peak-to-valley distance greater than said corrugations of said second of said sheet metal elements; and
said sheet metal elements aligned whereby each corrugation valley of each said corrugation of said first of said sheet metal elements contacts a corresponding corrugation valley of said second of said sheet metal elements, forming a coolant flow channel between each corrugation peak of said corrugations of said first of said sheet metal elements and a corresponding corrugation peak of said corrugations of said second of said sheet metal elements.

2. A fuel cell stack in accordance with claim 1, wherein said fuel cell unit is a fuel cell type selected from the group consisting of molten carbonate, solid oxide, phosphoric acid and polymer electrolyte membrane.

3. A fuel cell stack in accordance with claim 1, wherein said at least two sheet metal elements are constructed of a material selected from the group consisting of nickel, stainless steel, high alloy steel, titanium and metals coated to prevent corrosion.

4. A fuel cell stack in accordance with claim 2, wherein said fuel cell unit is a polymer electrolyte membrane fuel cell.

5. A fuel cell stack in accordance with claim 4, wherein said at least two sheet metal elements are constructed of a chromium-nickel austenitic alloy comprising on a combined basis at least about 50% by weight chromium and nickel.

6. A fuel cell stack in accordance with claim 1 further comprising a plurality of internal manifolds for supplying said fuel and oxidant to each of said fuel cell units and for removal of exhaust gases therefrom and for providing coolant to said coolant flow channels.

7. A fuel cell stack in accordance with claim 1, wherein said corrugation valleys have an arcuate profile.

8. In a fuel cell stack comprising a plurality of fuel cell units, each said fuel cell unit having an electrolyte-electrode-assembly with an anode electrode on one face and a cathode electrode on an opposite face, an anode current collector on said anode electrode side of said electrolyte-electrode-assembly and a cathode current collector on said cathode side of said electrolyte-electrode-assembly, and a separator plate disposed between said anode electrode side of said electrolyte-electrode-assembly of one said fuel cell unit and said cathode electrode side of said electrolyte-electrode-assembly of an adjacent said fuel cell unit having guide means for distributing fuel and oxidant gases to said anode electrode side and said cathode electrode side and forming an anode chamber between the anode electrode facing face of said separator plate and said anode electrode and forming a cathode chamber between the opposite cathode electrode facing face of said separator plate and the cathode electrode of an adjacent said fuel cell unit, said anode chamber in gas communication with a fuel gas supply and outlet and said cathode chamber in gas communication with an oxidant gas supply and outlet, the improvement comprising:
said separator plate constructed of at least two substantially coextensive sheet metal elements having a substantially fiat peripheral region and a central region comprising a plurality of substantially uniform corrugations, said corrugations of a first of said sheet metal elements and a second of said sheet metal elements having substantially equal peak-to-peak distances and said corrugations of said first of said sheet metal elements having a peak-to-valley distance greater than said corrugations of said second of said sheet metal elements;
said sheet metal elements aligned whereby each corrugation valley of each said corrugation of said first of said sheet metal elements contacts a corresponding corrugation valley of said second of said sheet metal elements, forming a coolant flow channel between each corrugation peak of said corrugations of said first of said sheet metal elements and a corresponding corrugation peak of said corrugations of said second of said sheet metal elements;
said separator plates having a flattened peripheral seal structure extending to contact one of said electrolyte-electrode-assemblies and said current collectors on each face of said separator plates completely around said anode chamber and said cathode chamber, respectively, forming a peripheral seal under cell operating conditions;
said electrolyte-electrode-assemblies and said separator plates each having a plurality of aligned perforations, said perforations in said separator plates being surrounded on said anode electrode facing face and said cathode electrode facing side by a flattened manifold seal structure extending to contact one of said electrolyte-electrode-assemblies and said current collectors on said anode electrode facing sides and said cathode electrode facing sides of said separator plates, forming a manifold seal under cell operating conditions to form a plurality of fuel gas and oxidant gas manifolds extending through said cell stack;
fuel conduits through said flattened manifold seal structure providing fuel gas communication between said fuel gas manifolds and said anode chambers on said anode electrode facing side of said separator plates, thereby providing fully internal manifolding of fuel to and from each said fuel cell unit in said fuel cell stack; and
oxidant conduits through said flattened manifold seal structure providing oxidant gas communication between said oxidant gas manifolds and said cathode chambers on said cathode electrode facing side of said separator plates, thereby providing fully internal manifolding of oxidant to and from each said fuel cell unit in said fuel cell stack.

9. A fuel cell stack in accordance with claim 8, wherein said separator plates and said electrolyte-electrode-assemblies form a plurality of aligned coolant fluid openings, said openings in said separator plates being surrounded on said anode electrode facing face and said cathode electrode facing side by a flattened coolant fluid manifold seal structure extending to contact one of said electrolyte-electrode-assemblies and said current collectors on said anode electrode facing sides and said cathode electrode facing sides of said separator plates, forming a coolant fluid manifold seal under cell operating conditions to form a plurality of coolant fluid manifolds extending through said cell stack.

10. A fuel cell stack in accordance with claim 8, wherein said fuel cell unit is a fuel cell type selected from the group consisting of molten carbonate, solid oxide, phosphoric acid and polymer electrolyte membrane.

11. A fuel cell stack in accordance with claim 8, wherein said at least two sheet metal elements are constructed of a material selected from the group consisting of nickel, stainless steel, high alloy steel, titanium and metals coated to prevent corrosion.

12. A fuel cell stack in accordance with claim 10, wherein said fuel cell unit is a polymer electrolyte membrane fuel cell.

13. A fuel cell stack in accordance with claim 12, wherein said at least two sheet metal elements are constructed of a chromium-nickel austenitic alloy comprising on a combined basis at least about 50% by weight chromium and nickel.

14. A fuel cell stack in accordance with claim 8, wherein said corrugation valleys have an arcuate profile.
